(19) United States
(12) Patent Application Publication
(10) Pub. No.: US 2026/0362161 A1
(43) Pub. Date: Nov. 12, 2026

(54) BEAM INFORMATION REPORT

(71) Applicant: ZTE Corporation, Shenzhen (CN)

(72) Inventors: Xiaolong GUO, Shenzhen (CN); Bo GAO, Shenzhen (CN); Yang ZHANG, Shenzhen (CN); Zhaohua LU, Shenzhen (CN); Ling YANG, Shenzhen (CN)

(21) Appl. No.: 19/722,097

(22) Filed: Jun. 26, 2026

Related U.S. Application Data
(63) Continuation of application No. PCT/CN2024/072807, filed on Jan. 17, 2024.

(51) Int. Cl. H04W 16/28; H04B 7/06; H04B 17/318; H04L 5/00; H04W 56/00; H04W 72/21; H04W 80/02

(52) U.S. Cl. CPC H04W 16/28; H04B 7/0626; H04B 17/328; H04L 5/0044; H04W 56/0015; H04W 72/21; H04W 80/02

(57) ABSTRACT

Techniques are described for transmission of a beam report. An example wireless communication method includes receiving, by a communication device, a configuration related to a beam report, wherein the configuration indicates one or more trigger events that triggers the communication device to transmit the beam report; and transmitting, by the communication device, the beam report in response to an occurrence of a trigger event from the one or more trigger events, wherein the beam report is transmitted by the communication device in an uplink resource or in an uplink transmission.

### CROSS-REFERENCE TO RELATED APPLICATION

This application is a continuation and claims priority to International Application No. PCT/CN2024/072807, filed on Jan. 17, 2024, the disclosure of which is hereby incorporated by reference herein in its entirety

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for a device (e.g., user equipment (UE)) to transmit beam information report in response to when a trigger event occurs. Thus, this patent document describes the following example technical solutions: a configuration that enables the device (e.g., UE) to perform the beam report, a transmission by the device (e.g., UE) of the beam report in a medium access control-control element (MAC CE) or a type of uplink control information(UCI), and a transmission by the device (e.g., UE) of the beam report in an uplink resource that is configured by network (e.g., base station) or is selected from a plurality of uplink resources within a time duration.

A first example wireless communication method includes receiving, by a communication device, a configuration related to a beam report, wherein the configuration indicates one or more trigger events that triggers the communication device to transmit the beam report; and transmitting, by the communication device, the beam report in response to an occurrence of a trigger event from the one or more trigger events, wherein the beam report is transmitted by the communication device in an uplink resource or in an uplink transmission.

In some embodiments, the uplink resource or the uplink transmission is based on a Type 1 or Type 2 configured grant physical uplink shared channel (PUSCH) transmission configured in the configuration related to the beam report. In some embodiments, the uplink resource or the uplink transmission is based on a Type 1 or Type 2 configured grant physical uplink shared channel (PUSCH) transmission configured to multiplex the beam report on the corresponding PUSCH transmission. In some embodiments, the uplink resource is a physical uplink control channel (PUCCH) resource configured for the beam report. In some embodiments, the uplink resource or the uplink transmission is based on a physical uplink shared channel (PUSCH) transmission determined based on a PUSCH transmission parameter configuration dedicated to the beam report.

In some embodiments, the uplink resource or the uplink transmission is based on a physical uplink shared channel (PUSCH) transmission determined based on a rule, and the rule specifies a PUSCH transmission parameter for the PUSCH transmission is based on the PUSCH transmission parameter indicated by a PDCCH scheduling a second PUSCH transmission other than the PUSCH transmission. In some embodiments, the uplink resource or the uplink transmission is one of a plurality of uplink resources or one of a plurality of uplink transmissions, and the plurality of uplink resources or the plurality of uplink transmissions are transmitted by the communication device within a transmission window. In some embodiments, the plurality of uplink resources or the plurality of uplink transmissions comprises at least one of following: a physical uplink control channel (PUCCH) indicated by a physical downlink control channel (PDCCH) to transmit within the transmission window, a physical uplink shared channel (PUSCH) scheduled by a PDCCH to transmit within the transmission window, a PUCCH resource carrying a periodic channel state information (CSI) report or a semi-persistent CSI report, a PUSCH with a Type 1 configured grant, or a PUSCH with a Type 2 configured grant activated by a PDCCH.

In some embodiments, the communication device performs rate matching for performing the transmitting or multiplexing the beam report in a physical uplink shared channel (PUSCH) transmission based on a configured beta offset value. In some embodiments, the configuration related to the beam report includes at least one of: a first configuration for a channel state information (CSI) report, wherein the first configuration indicates the one or more trigger events associated with the CSI report, a second configuration for the beam report that indicates at least one of the one or more trigger events, a report configuration identification, a reference signal for measurement, or a report quantity that indicates a content for the beam report, or a third configuration for the CSI report that includes a reporting configuration type set to event triggered. In some embodiments, the communication device transmits the beam report using a medium access control-control element (MAC CE) or a type of uplink control information (UCI).

In some embodiments, the beam report is transmitted using the MAC CE that includes at least one of: a presence indication of the beam report, a cell indicator, a reference signal resource indicator, a report quantity that indicates a content of the beam report, or an identification of the trigger event. In some embodiments, the beam report is transmitted using the MAC CE that is associated with only one beam report, or the beam report is transmitted using the MAC CE that is associated with one beam report quantity that is associated with a reference signal. In some embodiments, the beam report is transmitted using the MAC CE that is associated with more than one beam reports, or the beam report is transmitted using the MAC CE that is associated with more than one report quantity that is associated with more than one reference signals.

In some embodiments, the configuration related to the beam report configures a report quantity that indicates a content for the beam report, where at least one of following is configured: a reference signal receive power (RSRP) corresponds to an synchronization signal block (SSB) resource indicator, a RSRP corresponds to a channel state information reference signal resource indicator (CRI), a signal-to-noise and interference ratio (SINR) corresponds to a SSB index, or a SINR corresponds to a CRI. In some embodiments, the communication device receives a second configuration related to a beam report indication message, and the communication device transmits the beam report indication message to a network device based on the second configuration in response to the trigger event of at least one beam report, and the beam report indication message indicates to the network device that at least one beam report has been triggered by an event corresponding to the at least one beam report.

In some embodiments, the second configuration related to the beam report indication message includes a scheduling request configuration index or a physical uplink control channel (PUCCH) resource index. In some embodiments, a time or the transmission window for transmitting the beam report is based on the transmission time of the beam report indication message. In some embodiments, the time or the transmission window for transmitting the beam report starts or ends X milliseconds after the beam report indication message is transmitted, and a value for X is a physical uplink shared channel (PUSCH) preparation time, a configured value, or a predefined value. In some embodiments, the time or the transmission window for transmitting the beam report starts or ends at a symbol which is Y symbols later than an end symbol of the beam report indication message, and a value of Y is configured or predefined. In some embodiments, the time or the transmission window for transmitting the beam report starts or ends at a slot which is Z slots later than another slot in which the beam report indication message is transmitted, and a value of Z is configured or predefined.

A second example wireless communication includes transmitting, by a network device, a configuration related to a beam report, wherein the configuration indicates one or more trigger events that triggers a communication device to transmit the beam report; and receiving, by the network device from the communication device, the beam report in response to an occurrence of a trigger event from the one or more trigger events, wherein the beam report is received in an uplink resource or in an uplink transmission.

In some embodiments, the uplink resource or the uplink transmission is based on a Type 1 or Type 2 configured grant physical uplink shared channel (PUSCH) transmission configured in the configuration related to the beam report. In some embodiments, the uplink resource or the uplink transmission is based on a Type 1 or Type 2 configured grant physical uplink shared channel (PUSCH) transmission configured to multiplex the beam report on the corresponding PUSCH transmission. In some embodiments, the uplink resource is a physical uplink control channel (PUCCH) resource configured for the beam report. In some embodiments, the uplink resource or the uplink transmission is based on a physical uplink shared channel (PUSCH) transmission determined based on a PUSCH transmission parameter configuration dedicated to the beam report.

In some embodiments, the uplink resource or the uplink transmission is based on a physical uplink shared channel (PUSCH) transmission determined based on a rule, and the rule specifies a PUSCH transmission parameter for the PUSCH transmission is based on the PUSCH transmission parameter indicated by a PDCCH scheduling a second PUSCH transmission other than the PUSCH transmission. In some embodiments, the uplink resource or the uplink transmission is one of a plurality of uplink resources or one of a plurality of uplink transmissions, and the plurality of uplink resources or the plurality of uplink transmissions are transmitted within a transmission window. In some embodiments, the plurality of uplink resources or the plurality of uplink transmissions comprises at least one of following: a physical uplink control channel (PUCCH) indicated by a physical downlink control channel (PDCCH) to transmit within the transmission window, a physical uplink shared channel (PUSCH) scheduled by a PDCCH to transmit within the transmission window, a PUCCH resource carrying a periodic channel state information (CSI) report or a semi-persistent CSI report, a PUSCH with a Type 1 configured grant, or a PUSCH with a Type 2 configured grant activated by a PDCCH.

In some embodiments, the configuration related to the beam report includes at least one of: a first configuration for a channel state information (CSI) report, wherein the first configuration indicates the one or more trigger events associated with the CSI report, a second configuration for the beam report that indicates at least one of the one or more trigger events, a report configuration identification, a reference signal for measurement, or a report quantity that indicates a content for the beam report, or a third configuration for the CSI report that includes a reporting configuration type set to event triggered. In some embodiments, the network device receives the beam report using a medium access control-control element (MAC CE) or a type of uplink control information (UCI).

In some embodiments, the beam report is received using the MAC CE that includes at least one of: a presence indication of the beam report, a cell indicator, a reference signal resource indicator, a report quantity that indicates a content of the beam report, or an identification of the trigger event. In some embodiments, the beam report is received using the MAC CE that is associated with only one beam report, or the beam report is received using the MAC CE that is associated with one beam report quantity that is associated with a reference signal. In some embodiments, the beam report is received using the MAC CE that is associated with more than one beam reports, or the beam report is received using the MAC CE that is associated with more than one report quantity that is associated with more than one reference signals. In some embodiments, the configuration related to the beam report configures a report quantity that indicates a content for the beam report, where at least one of following is configured: a reference signal receive power (RSRP) corresponds to an synchronization signal block (SSB) resource indicator, a RSRP corresponds to a channel state information reference signal resource indicator (CRI), a signal-to-noise and interference ratio (SINR) corresponds to a SSB index, or a SINR corresponds to a CRI.

In some embodiments, the network device transmits a second configuration related to a beam report indication message, the network device receives the beam report indication message from the communication device based on the second configuration in response to the trigger event of at least one beam report, and the beam report indication message indicates to the network device that at least one beam report has been triggered by an event corresponding to the at least one beam report. In some embodiments, the second configuration related to the beam report indication message includes a scheduling request configuration index or a physical uplink control channel (PUCCH) resource index. In some embodiments, a time or the transmission window for receiving the beam report is based on the transmission time of the beam report indication message. In some embodiments, the time or the transmission window for receiving the beam report starts or ends X milliseconds after the beam report indication message is transmitted, and a value for X is a physical uplink shared channel (PUSCH) preparation time, a configured value, or a predefined value.

In some embodiments, the time or the transmission window for receiving the beam report starts or ends at a symbol which is Y symbols later than an end symbol of the beam report indication message, and a value of Y is configured or predefined. In some embodiments, the time or the transmission window for receiving the beam report starts or ends at a slot which is Z slots later than another slot in which the beam report indication message is transmitted, and a value of Z is configured or predefined.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example beam report MAC CE with one report.

FIG. 2 shows an example beam report MAC CE with multiple reports.

FIGS. 3 to 5 show example flowcharts or a communication device to transmit a beam report.

FIG. 6 shows an example of available uplink resources that can be used to carry a beam report within the beam report transmission window.

FIG. 7 shows an exemplary block diagram of a hardware platform that may be a part of a network device or a communication device.

FIG. 8 shows an example of wireless communication including a base station (BS) and user equipment (UE) based on some implementations of the disclosed technology.

FIG. 9 shows an exemplary flowchart for transmitting a beam report.

FIG. 10 shows an exemplary flowchart for receiving a beam report.

### DETAILED DESCRIPTION

Channel state information (CSI) report in the current NR system can assist a network to provide a better transmission configuration to a UE. A CSI report can be configured to be aperiodic, semi-persistent or periodic. For aperiodic CSI (AP-CSI) report triggering, a single set of CSI triggering states are higher layer configured. UE can receive a DCI format to activate a CSI trigger state or a CSI reporting. For semi-persistent CSI (SP-CSI) reporting on PUSCH, a set of trigger states are configured by higher layer, where the CSI request field in DCI scrambled with SP-CSI-RNTI activates one of the trigger states. For semi-persistent reporting on physical uplink control channel (PUCCH), the PUCCH resource used for transmitting the CSI report are configured by RRC signaling. Semi-persistent reporting on PUCCH is activated by an activation command which selects one of the semi-persistent Reporting Settings for use by the UE on the PUCCH. For periodic CSI reporting, the report periodicity, slot offset and PUCCH resource for the report are configured.

A UE can be configured with the report quantity for a CSI Report to contain one or more of Channel quality indicator (CQI), Precoding matrix indicator (PMI), rank indicator (RI), CSI-RS Resource Indicator (CRI), synchronization signal block resource indicator (SSBRI), signal-to-noise and interference ratio (SINR), or reference signal received power (RSRP). The report quantity can indicate a report content to the UE (e.g., the report quantity indicates to the UE whether a report is to contain CQI, PMI, RI, CRI, SSBRI, SINR, and/or RSRP). UE calculates the corresponding CSI parameter based on the configured report quantity and corresponding CSI resources for measurement.

Measurement reporting is to transfer measurement results from the UE to the network. The UE shall initiate measurement reporting only after successful Access Stratum(AS) security activation. The measurement reporting is performed by higher layers of UE (e.g., Layer 3), and a plurality of measurement report triggering events can be configured for a report configuration. The triggering events are mainly related to higher layer parameters, e.g., serving cell or neighboring cell measurement result, interference measurement result, channel busy ratio, or UE location. Signaling radio bearer of the measurement report is SRB1 and SRB3, and the logical channel is Dedicated Control Channel (DCCH).

The Scheduling Request (SR) is used for requesting UL-SCH resources for new transmission. The MAC entity may be configured with zero, one, or more SR configurations. An SR configuration consists of a set of PUCCH resources for SR across different BWPs and cells. The SR configuration of the logical channel that triggered a Buffer Status Reporting or the SCell beam failure recovery or the beam failure recovery of BFD-RS set or the consistent LBT failure recovery or positioning measurement gap activation/deactivation request is considered as corresponding SR configuration for the triggered SR.

Uplink control information (UCI) types include HARQ-ACK information, scheduling request (SR), link recovery request (LRR), and CSI. UCI bits include HARQ-ACK information bits, if any, SR information bits, if any, LRR information bit, if any, and CSI bits, if any. Normally SR is applicable for SR and/or for LRR in NR systems.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

Beam information report is based on CSI report currently, and the report type in time domain behavior can be configured to be periodical, semi-persistent or aperiodical. In such methods, UE will report all the information associated with the reference signals configured for CSI report, which results in a large report overhead. Meanwhile, report latency for CSI report is large as well, especially for semi-persistent and periodical CSI report, due to UE should perform CSI report based on the report period rather than a flexible report timing.

This patent document specifies methods of beam information report triggered by events, i.e., UE is enabled to report a beam information only if a configured event occurs. In such method, the report overhead is reduced as UE does not need to report information of all the configured reference signals. Furthermore, UE is allowed to perform beam report upon an event is triggered and without DCI activating a report, report latency is reduced as well.

In this patent document, the following example techniques or example aspects are specified:
(1) The configuration which enables a UE to perform beam report triggered by events.
(2) The container and contents of a beam report, e.g., a beam report can comprise a medium access control-control element (MAC CE), a CSI report or a new type of UCI.
(3) A beam report indication message (optional) can be transmitted by a UE before transmitting a beam report, wherein the beam report indication message is used to indicate to network that a beam report has been triggered or a beam report are requested by UE to transmit.
(4) When a beam report indication message is transmitted, a time duration (also known as time window) within which a UE should transmitted a beam report is specified. Network can be aware of timing of a beam report based on the time duration and a former beam report indication message.
(5) UE determines an uplink transmission or uplink resource to carry the generated beam report, wherein the uplink transmission can be an uplink transmission which has been configured, scheduled, indicated by network to be transmitted by UE, or an uplink transmission which is dedicated to carry a beam report.

### II. Example Solutions

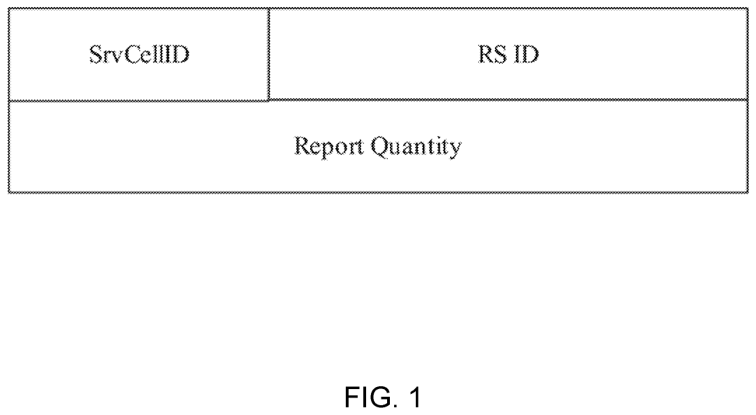

FIG. 1 shows an example beam report MAC CE with one report. In the example FIG. 1, a beam report MAC CE contains fields indicating serving cell index, reference signal index for beam report and report quantity of a beam report.

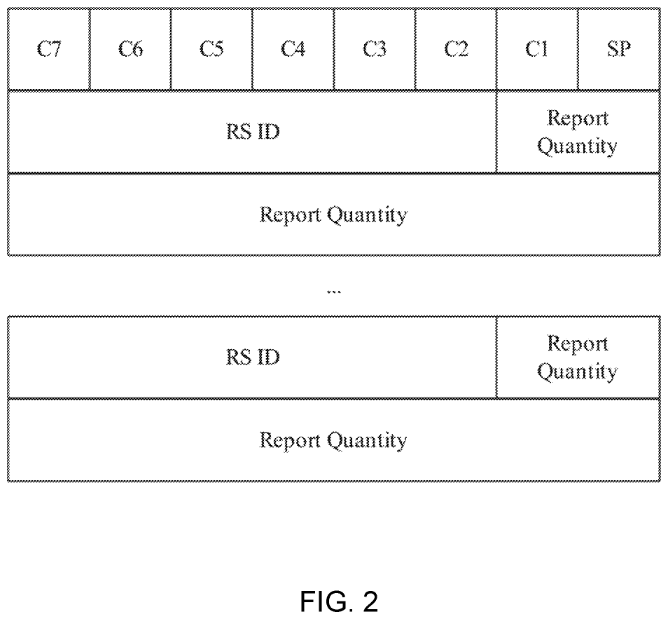

FIG. 2 shows an example beam report MAC CE with multiple reports. In the example FIG. 2, a beam report MAC CE with a variable size contains fields indicating beam report presence of a serving cell, reference signal(RS) index for beam report and report quantity of a beam report. If the field indicates that the beam report corresponds to the serving cell is present (SP, C1, C2, . . . C7 corresponds to SpCell, serving cell index 1, serving cell index 2, . . . , serving cell index 7 respectively), the RS ID and Report quantity fields for the corresponding serving cell is present in the MAC CE, otherwise the fields are absent.

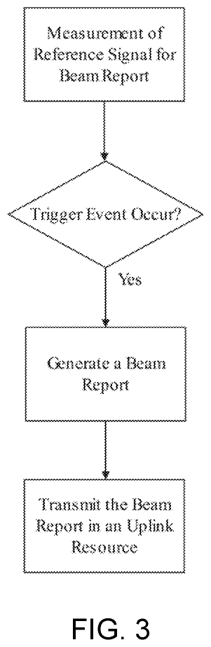

FIGS. 3 to 5 show example flowcharts or a communication device to transmit a beam report. In the example FIG. 3, a event triggering a beam report can occur according to measurement of reference signals for beam report. Upon the event triggering, UE generates a beam report (e.g., MAC CE or UCI) and transmits the beam report in an uplink resource.

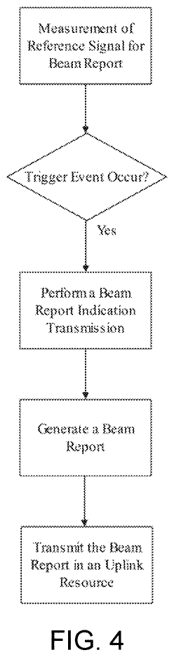

In the example FIG. 4, an event triggering a beam report can occur according to measurement of reference signals for beam report. Upon the event triggering, UE firstly performs a beam report indication message transmission to network, then generates a beam report (e.g., MAC CE or UCI) and transmits the beam report in an uplink resource to network.

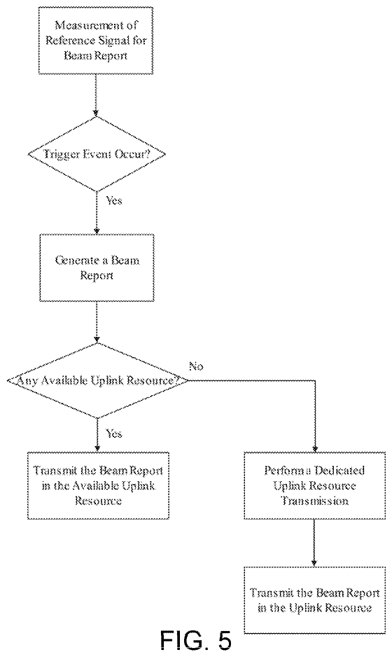

In the example FIG. 5, UE determines an uplink resource to carry a generated beam report based on an available uplink resource or a dedicated uplink resource.

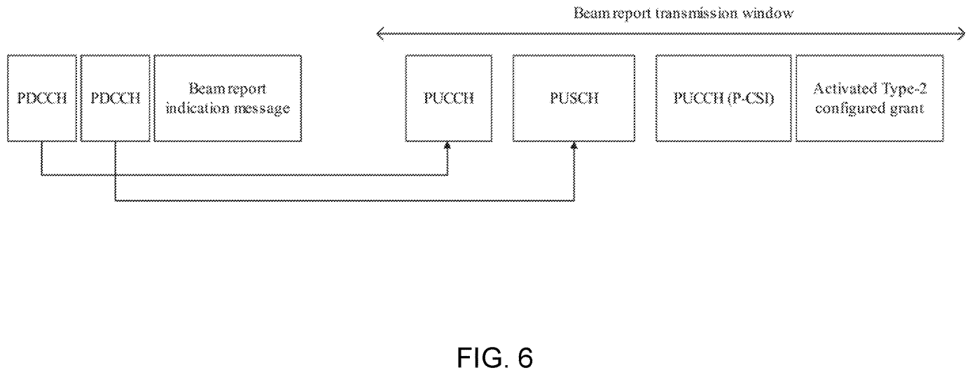

FIG. 6 shows an example of available uplink resources that can be used to carry a beam report within the beam report transmission window. In FIG. 6, the available uplink resources may include, for example, a PUCCH scheduled by a PDCCH, a PUSCH scheduled by a PDCCH, a PUCCH configured to carry periodic CSI(P-CSI) and an activated Type-2 configured grant PUSCH.

In this patent document, a beam report can be equivalent to or can be the same as a UE-triggered beam report, an event triggered beam report, or a channel state information (CSI) report triggered by event. In this patent document, RSRP may comprise L1-RSRP, and SINR may comprise L1-SINR value. A cell may comprise a serving cell, a physical cell, a TRP, a CORESET pool, a candidate cell, a neighbor cell, a node or an access point.

Each of the embodiments described below can use the features and/or technology described in Section II to transmit a beam report.

### II.a. Embodiment 1

Embodiment 1 specifies a UE receiving a configuration of beam report which indicates or enables UE to perform beam reporting triggered by one or more trigger events.

A beam report is triggered if any one of the events configured occur according to the measurement result of a corresponding reference signal for the beam report. A trigger event may specify a condition related to the measurement result of a reference signal and/or a threshold (e.g., an inequality related to the measurement result and the threshold). When the measurement result of a reference signal satisfies the condition, it is considered as a trigger event occurrence associated with the reference signal. In one example, a trigger event occurrence is defined as the condition of Measurement result+ConfigPara>Threshold is satisfied, wherein ConfigPara and Threshold can be configured for the corresponding event, when the measurement result of a reference signal satisfies the condition, the event is triggered.

In some embodiments, UE performs beam reporting based on the trigger events and measurement of reference signals when UE receives at least one of the following configurations from network:
(1) a configuration for CSI report, wherein the configuration indicates one or more trigger events.
(2) a configuration for event triggered beam report, wherein the configuration indicates at least one of a trigger event, a report configuration identification, a reference signal for measurement or a report quantity for a beam report;
(3) a configuration for CSI report, wherein reporting configuration type is configured to ‘event triggered’.

In some embodiments, the configuration of a beam report indicates a priority for the beam report or for the trigger event associated with the beam report. The priority of a beam report is determined based on the priority for the beam report or the priority for the event which triggers the beam report.

### II.b. Embodiment 2

Embodiment 2 specifies a UE transmitting a beam report using a MAC CE or a type of uplink control information.

In some embodiments, a beam report comprises a MAC CE, wherein at least one of: a presence indication of a beam report that indicates whether the beam report is present, cell indicator (e.g., candidate cell index, serving cell index or physical cell index), reference signal resource indicator (e.g., SSB resource index or CSI resource index), report quantity, or identification of trigger event are indicated.

In some embodiments, a MAC CE is associated with only one beam report. In some embodiments, a MAC CE includes one report quantity field associated with a reference signal.

In some embodiments, a MAC CE is associated with more than one beam reports. In some embodiments, a MAC CE includes more than one report quantity fields associated with more than one reference signals.

In some embodiments, when presence indication of a beam report indicates the corresponding beam report has not been triggered (e.g., set to 0), the octets containing the field for reference signal index, report quantity or trigger event identification if any are absent in the MAC CE.

In some embodiments, a beam report comprises a channel state information (CSI) report. A beam report can be transmitted in a Part 1 CSI report or transmitted in both Part 1 and Part 2 CSI report.

In some embodiments, a beam report comprises a new type of uplink control information (e.g., uplink control information-beam report, UCI-BR).

In embodiments above, report quantity for a beam report can be configured by network, wherein the network configures at least one of: RSRP to correspond to an SSB resource, RSRP to correspond to a CSI-RS resource, SINR to correspond to an SSB resource or SINR to correspond to a CSI-RS.

In some embodiments, RSRP or SINR can be an absolute value, a range of absolute value, a difference value or a range of difference value.

In one example, the reported RSRP is −50 dB.

In one example, the reported RSRP is mapped to a range of [−50, −40) dB.

In one example, the reported RSRP is −5 dB different from a reference RSRP value.

In one example, the reported RSRP is mapped to a range of [+5, −5) dB different from a reference RSRP value. The reference RSRP value can be associated with a reference signal of serving cell.

In some embodiments, network configures the report quantity based on a UE capability.

In one example, UE reports the capability of supporting report quantity of RSRP and SINR corresponds to an SSB index, and network configures the report quantity to UE to be either SSB-index-RSRP or SSB-index-SINR.

### II.c. Embodiment 3

Embodiment 3 specifies a UE transmitting a beam report indication message to network before transmitting a beam report, and further to specify UE transmitting the beam report within a time duration (also known as time window) after UE transmitting the beam report indication message.

In some embodiments, a UE receives a configuration of beam report indication message, wherein the beam report indication message is transmitted by UE to network to indicate that at least one beam report has been triggered by its corresponding event(s) or at least one beam report is requested by UE to be transmitted later than the beam report indication message transmission. The configuration of the beam report indication message configures a UE with the uplink resource (e.g., PUCCH resource index or scheduling request configuration index) for a beam report indication message.

The configuration of beam report indication message indicates a scheduling request configuration index or a PUCCH resource index.

In one example, a UE can be configured by schedulingRequestID-BeamReport a scheduling request configuration used by UE upon a beam report triggering.

In one example, a UE can be configured by PUCCH-BeamReportIndication-Resource a PUCCH resource with either PUCCH format 0 or PUCCH format 1.

Each logical channel, SCell beam failure recovery, beam failure recovery of BFD-RS set and consistent LBT failure recovery, event triggered beam report, may be mapped to zero or one SR configuration.

In some embodiments, UE determines a time duration (called beam report transmission window hereinafter) for a beam report after UE transmitting a beam report indication message, wherein the time duration is determined based on at least one of the following:
(1) the time duration starts or ends X milliseconds after the beam report indication message, wherein value of X can be determined according to (or based on) at least one of a PUSCH preparation time, a configured value or a predefined value. In some embodiments, the value of X can be a PUSCH preparation time, a configured value or a predefined value;
(2) the time duration starts or ends at the symbol which is Y symbols later than the end symbol of the beam report indication message, wherein value of Y can be configured or predefined;
(3) the time duration starts or ends at the slot which is Z slots later than the slot in which the beam report indication message is transmitted, wherein value of Z can be configured or predefined (e.g., 0, 1, 2, etc.).

The time duration is used to specify UE to transmit a beam report within the time duration, or to transmit a beam report no later than the ending of the time duration.

### II.d. Embodiment 4

Embodiment 4 specifies a UE transmitting a beam report triggered by a trigger event in an uplink resource or uplink transmission.

### Example Scheme-A

In some embodiments, the uplink resource or uplink transmission to carry/multiplex a beam report is determined based on at least one of the following:
(1) a Type 1 or Type 2 configured grant PUSCH transmission configured in the configuration of beam report or CSI report. In one example, an identification of a configured grant PUSCH transmission (e.g., ConfiguredGrantConfigIndex) is indicated in the beam report configuration or CSI report configuration.
(2) a Type 1 or Type 2 configured grant PUSCH transmission configured to multiplex a beam report on the corresponding PUSCH transmission. In one example, a CSI report ID or UE triggered beam report ID can be indicted in a configuration of PUSCH transmission with configured grant. In another example, an enabling indication can be indicated in a configuration of PUSCH transmission with configured grant. If the field is present or is set enabled, UE multiplex UCI-BR on the PUSCH transmission with configured grant.
(3) a PUCCH resource configured for a beam report. In one example, one or more PUCCH resources can be configured in the configuration of a beam report.
(4) a PUSCH transmission determined based on a PUSCH transmission configuration dedicated to a beam report, wherein the configuration configures at least one of the following PUSCH transmission parameters: frequency Hopping type, modulation and coding scheme (MCS), frequency domain resource assignment (FDRA), time domain resource assignment(TDRA), antenna port, SRS resource, transmission precoding or transmission layer.
(5) a PUSCH transmission determined based on a rule, wherein the rule specifies at least one of: TDRA for the PUSCH transmission is based on the first element in the PUSCH TDRA list; PUSCH transmission parameter for the PUSCH transmission is based on the PUSCH transmission parameter indicated by a recently received PDCCH scheduling a PUSCH transmission before a beam report indication message transmission; PUSCH transmission parameter for the PUSCH transmission is based on the PUSCH transmission parameter for another PUSCH transmission recently transmitted by UE before a beam report indication message transmission.
(6) a PUSCH transmission scheduled by a PDCCH to multiplex the beam report.

In some embodiments, the PDCCH scheduling a PUSCH transmission to multiplex a beam report is received after UE transmits a beam report indication message, and the beam report indication message is associated with the beam report.

In some embodiments, the PDCCH indicates at least one of a trigger state, a report configuration index, or a non-zero CSI request associated with the beam report.

In some embodiments, an indication field in the PDCCH indicates that the scheduled PUSCH transmission is to multiplex a beam report. In one example, if the indication field indicates a value of 1 or a non-zero value, UE multiplex or transmit a beam report in the PUSCH transmission scheduled by the PDCCH.

In some embodiments, UE does not expect to be indicated non-zero values for both CSI request field and the indication field in a PDCCH.

In some embodiments, the PUSCH transmission configuration dedicated to a beam report indicates an identification of a PUSCH TDRA in the PUSCH TDRA list, wherein identification value 0 refers to the first PUSCH TDRA in the list, value 1 refers to the second PUSCH TDRA in the list, and so on.

In some embodiments, if UE transmits a beam report in a Type-2 configured grant PUSCH transmission without reception of a PDCCH activating the Type-2 configure grant, UE deactivates or releases the Type-2 configured grant when receives an indication indicative of deactivation of the configured grant from a PDCCH (e.g., an indication field of a PDCCH scrambled with a Configured Scheduling RNTI(CS-RNTI) indicates to deactivate a configured grant).

In some embodiments, if UE transmits a beam report in a Type-2 configured grant PUSCH transmission without reception of a PDCCH activating the Type-2 configured grant, UE sets the field indicating whether activation or deactivation of the corresponding configured grant has been received or whether the corresponding configured grant has been activated by the UE in a configured grant confirmation MAC CE to 1, i.e., the field indicates that the activation or deactivation of the configured grant has been received, or the configured grant has been activated by UE without reception of the activation.

In some embodiments, after UE transmitting a beam report in a Type-2 configured grant PUSCH transmission without reception of a PDCCH activating the Type-2 configured grant, UE deactivates the Type-2 configured grant PUSCH without reception of a PDCCH deactivating the Type-2 configured grant.

In some embodiments, UE is configured with a transmission period of an uplink resource for a beam report, and UE transmits the uplink resource in a slot or a frame based on the transmission period.

In some embodiments, UE determines to transmit the uplink resource or not in the slot or frame based on whether a beam report is transmitted or multiplexed in the uplink resource. In one example, if UE does not multiplex a beam report in the uplink resource (e.g., due to overlapping handling or no beam report is generated), UE does not transmit the uplink resource in the slot or frame determined based on the transmission period.

### Example Scheme-B

In some embodiments, the uplink resource or uplink transmission carrying a beam report is determined to be one of a plurality of uplink resources or a plurality of uplink transmissions within the beam report transmission window, wherein the determined uplink resource or uplink transmission for beam report comprises at least one of the following:
(1) a PUCCH indicated by a PDCCH (e.g., by pdsch-to-HARQ_feedback timing indicator field) to transmit within the beam report transmission window;
(2) a PUSCH scheduled by a PDCCH to transmit within the beam report transmission window;
(3) a PUCCH resource carrying periodic CSI report or semi-persistent CSI report;
(4) a PUSCH with Type 1 configured grant;
(5) a PUSCH with Type 2 configured grant activated by a PDCCH.

In some embodiments, reception time of a PDCCH associated with the plurality of uplink resource or uplink transmission for a beam report satisfies at least one of the following conditions:
(1) the PDCCH is received before PUSCH preparation time for the UE capability from the start symbol or start slot of the time duration
(2) the PDCCH is received before or after beam report indication message associated with the beam report.

In some embodiments, the one of a plurality of uplink resources or uplink transmissions determined to carry a beam report is determined based on at least one of the following:
(1) the uplink transmission starts in the earliest symbol among the plurality of uplink transmissions;
(2) the uplink transmission ends in the latest symbol among the plurality of uplink transmissions;
(3) the uplink transmission with the same priority as the beam report;
(4) the uplink transmission with a higher priority;
(5) the uplink transmission capable of carrying the beam report, e.g., having available bits for the beam report or having available resource elements for the beam report;
(6) the uplink transmission with a transport block;
(7) the uplink transmission carrying a specific type of UCI, e.g., HARQ-ACK, SR or CSI part 1;
(8) the uplink transmission with or without repetitions.

In some embodiments, a UE shall not transmit anything on the resources configured by configuredGrantConfig if the higher layers did not deliver a transport block to transmit on the resources allocated for uplink transmission without grant and if a beam report is not transmitted or multiplexed on the resources when UE receives a configuration of beam report.

In some embodiments, UE determines the uplink transmission for a beam report based on example scheme-A when there are no available uplink resources for beam report within the beam report transmission window (example scheme-B).

In some embodiments, UE determines the uplink transmission for a beam report based on example scheme-A or example scheme-B according to the configuration and UE capability.

In some embodiments, UE performs rate matching for transmitting or multiplexing a beam report in a PUSCH transmission based on a beta offset value, wherein the beta offset value can be configured for CSI part 1, CSI part 2 or UCI for beam report in the configuration of PUSCH (e.g., PUSCH-Config) or configured grant (e.g., ConfiguredGrantConfig).

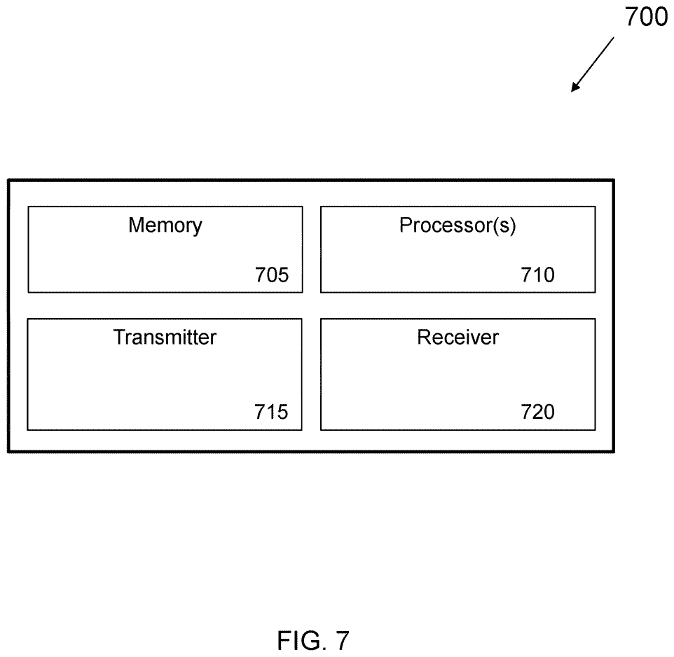

FIG. 7 shows an exemplary block diagram of a hardware platform 700 that may be a part of a network device (e.g., base station) or a communication device (e.g., a user equipment (UE)). The hardware platform 700 includes at least one processor 710 and a memory 705 having instructions stored thereupon. The instructions upon execution by the processor 710 configure the hardware platform 700 to perform the operations described in FIGS. 1 to 6 and 8 to 10 and in the various embodiments described in this patent document. The transmitter 715 transmits or sends information or data to another device. For example, a network device transmitter can send a message to a user equipment. The receiver 720 receives information or data transmitted or sent by another device. For example, a user equipment can receive a message from a network device.

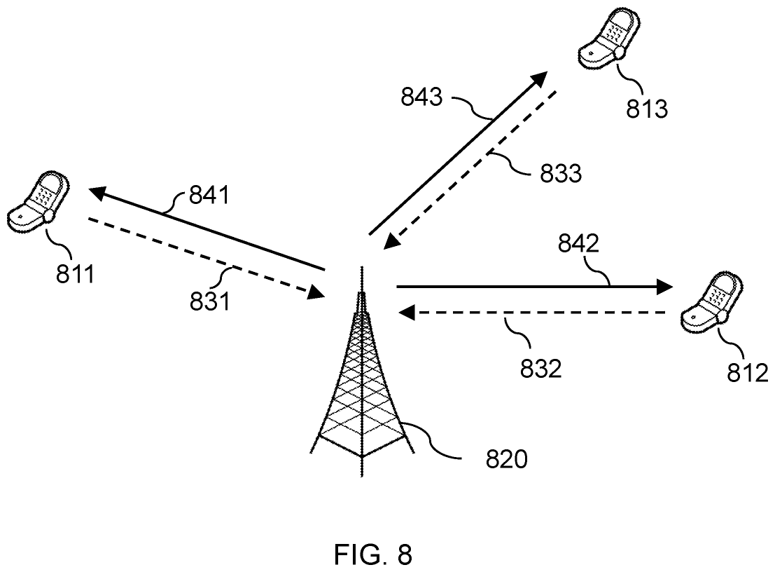

The implementations as discussed above will apply to a wireless communication. FIG. 8 shows an example of a wireless communication system (e.g., a 5G or NR cellular network) that includes a base station 820 and one or more user equipment (UE) 811, 812 and 813. In some embodiments, the UEs access the BS (e.g., the network) using a communication link to the network (sometimes called uplink direction, as depicted by dashed arrows 831, 832, 833), which then enables subsequent communication (e.g., shown in the direction from the network to the UEs, sometimes called downlink direction, shown by arrows 841, 842, 843) from the BS to the UEs. In some embodiments, the BS send information to the UEs (sometimes called downlink direction, as depicted by arrows 841, 842, 843), which then enables subsequent communication (e.g., shown in the direction from the UEs to the BS, sometimes called uplink direction, shown by dashed arrows 831, 832, 833) from the UEs to the BS. The UE may be, for example, a smartphone, a tablet, a mobile computer, a machine to machine (M2M) device, an Internet of Things (IoT) device, and so on.

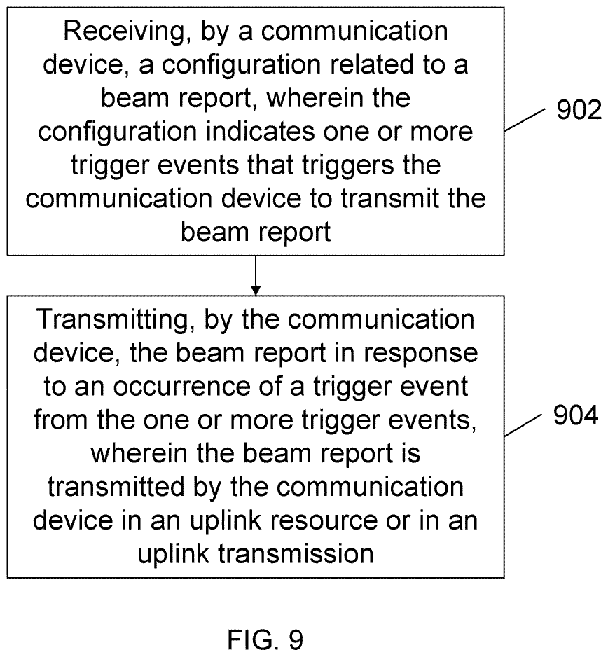

FIG. 9 shows an exemplary flowchart for transmitting a beam report. Operation 902 includes receiving, by a communication device, a configuration related to a beam report, wherein the configuration indicates one or more trigger events that triggers the communication device to transmit the beam report. Operation 904 includes transmitting, by the communication device, the beam report in response to an occurrence of a trigger event from the one or more trigger events, wherein the beam report is transmitted by the communication device in an uplink resource or in an uplink transmission.

In some embodiments, the uplink resource or the uplink transmission is based on a Type 1 or Type 2 configured grant physical uplink shared channel (PUSCH) transmission configured in the configuration related to the beam report. In some embodiments, the uplink resource or the uplink transmission is based on a Type 1 or Type 2 configured grant physical uplink shared channel (PUSCH) transmission configured to multiplex the beam report on the corresponding PUSCH transmission. In some embodiments, the uplink resource is a physical uplink control channel (PUCCH) resource configured for the beam report. In some embodiments, the uplink resource or the uplink transmission is based on a physical uplink shared channel (PUSCH) transmission determined based on a PUSCH transmission parameter configuration dedicated to the beam report.

In some embodiments, the uplink resource or the uplink transmission is based on a physical uplink shared channel (PUSCH) transmission determined based on a rule, and the rule specifies a PUSCH transmission parameter for the PUSCH transmission is based on the PUSCH transmission parameter indicated by a PDCCH scheduling a second PUSCH transmission other than the PUSCH transmission. In some embodiments, the uplink resource or the uplink transmission is one of a plurality of uplink resources or one of a plurality of uplink transmissions, and the plurality of uplink resources or the plurality of uplink transmissions are transmitted by the communication device within a transmission window. In some embodiments, the plurality of uplink resources or the plurality of uplink transmissions comprises at least one of following: a physical uplink control channel (PUCCH) indicated by a physical downlink control channel (PDCCH) to transmit within the transmission window, a physical uplink shared channel (PUSCH) scheduled by a PDCCH to transmit within the transmission window, a PUCCH resource carrying a periodic channel state information (CSI) report or a semi-persistent CSI report, a PUSCH with a Type 1 configured grant, or a PUSCH with a Type 2 configured grant activated by a PDCCH.

In some embodiments, the communication device performs rate matching for performing the transmitting or multiplexing the beam report in a physical uplink shared channel (PUSCH) transmission based on a configured beta offset value. In some embodiments, the configuration related to the beam report includes at least one of: a first configuration for a channel state information (CSI) report, wherein the first configuration indicates the one or more trigger events associated with the CSI report, a second configuration for the beam report that indicates at least one of the one or more trigger events, a report configuration identification, a reference signal for measurement, or a report quantity that indicates a content for the beam report, or a third configuration for the CSI report that includes a reporting configuration type set to event triggered. In some embodiments, the communication device transmits the beam report using a medium access control-control element (MAC CE) or a type of uplink control information (UCI).

In some embodiments, the beam report is transmitted using the MAC CE that includes at least one of: a presence indication of the beam report, a cell indicator, a reference signal resource indicator, a report quantity that indicates a content of the beam report, or an identification of the trigger event. In some embodiments, the beam report is transmitted using the MAC CE that is associated with only one beam report, or the beam report is transmitted using the MAC CE that is associated with one beam report quantity that is associated with a reference signal. In some embodiments, the beam report is transmitted using the MAC CE that is associated with more than one beam reports, or the beam report is transmitted using the MAC CE that is associated with more than one report quantity that is associated with more than one reference signals.

In some embodiments, the configuration related to the beam report configures a report quantity that indicates a content for the beam report, where at least one of following is configured: a reference signal receive power (RSRP) corresponds to an synchronization signal block (SSB) resource indicator, a RSRP corresponds to a channel state information reference signal resource indicator (CRI), a signal-to-noise and interference ratio (SINR) corresponds to a SSB index, or a SINR corresponds to a CRI. In some embodiments, the communication device receives a second configuration related to a beam report indication message, and the communication device transmits the beam report indication message to a network device based on the second configuration in response to the trigger event of at least one beam report, and the beam report indication message indicates to the network device that at least one beam report has been triggered by an event corresponding to the at least one beam report.

In some embodiments, the second configuration related to the beam report indication message includes a scheduling request configuration index or a physical uplink control channel (PUCCH) resource index. In some embodiments, a time or the transmission window for transmitting the beam report is based on the transmission time of the beam report indication message. In some embodiments, the time or the transmission window for transmitting the beam report starts or ends X milliseconds after the beam report indication message is transmitted, and a value for X is a physical uplink shared channel (PUSCH) preparation time, a configured value, or a predefined value. In some embodiments, the time or the transmission window for transmitting the beam report starts or ends at a symbol which is Y symbols later than an end symbol of the beam report indication message, and a value of Y is configured or predefined. In some embodiments, the time or the transmission window for transmitting the beam report starts or ends at a slot which is Z slots later than another slot in which the beam report indication message is transmitted, and a value of Z is configured or predefined.

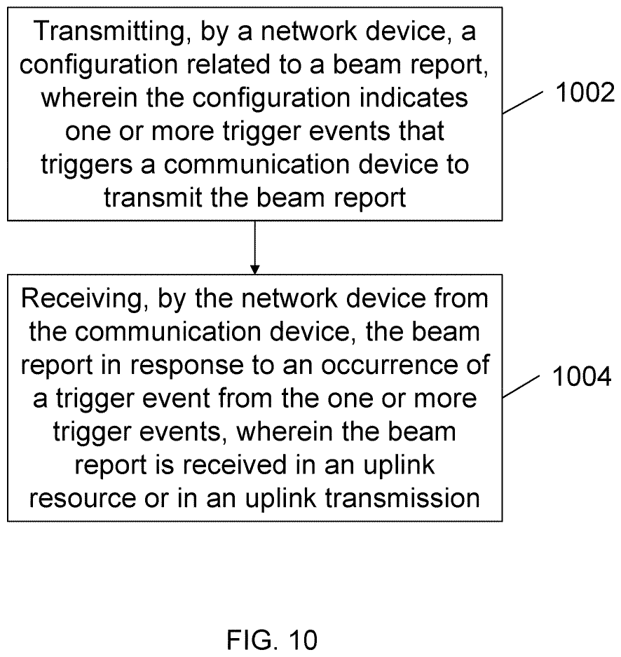

FIG. 10 shows an exemplary flowchart for receiving a beam report. Operation 1002 includes transmitting, by a network device, a configuration related to a beam report, wherein the configuration indicates one or more trigger events that triggers a communication device to transmit the beam report. Operation 1004 includes receiving, by the network device from the communication device, the beam report in response to an occurrence of a trigger event from the one or more trigger events, wherein the beam report is received in an uplink resource or in an uplink transmission.

In some embodiments, the uplink resource or the uplink transmission is based on a Type 1 or Type 2 configured grant physical uplink shared channel (PUSCH) transmission configured in the configuration related to the beam report. In some embodiments, the uplink resource or the uplink transmission is based on a Type 1 or Type 2 configured grant physical uplink shared channel (PUSCH) transmission configured to multiplex the beam report on the corresponding PUSCH transmission. In some embodiments, the uplink resource is a physical uplink control channel (PUCCH) resource configured for the beam report. In some embodiments, the uplink resource or the uplink transmission is based on a physical uplink shared channel (PUSCH) transmission determined based on a PUSCH transmission parameter configuration dedicated to the beam report.

In some embodiments, the uplink resource or the uplink transmission is based on a physical uplink shared channel (PUSCH) transmission determined based on a rule, and the rule specifies a PUSCH transmission parameter for the PUSCH transmission is based on the PUSCH transmission parameter indicated by a PDCCH scheduling a second PUSCH transmission other than the PUSCH transmission. In some embodiments, the uplink resource or the uplink transmission is one of a plurality of uplink resources or one of a plurality of uplink transmissions, and the plurality of uplink resources or the plurality of uplink transmissions are transmitted within a transmission window. In some embodiments, the plurality of uplink resources or the plurality of uplink transmissions comprises at least one of following: a physical uplink control channel (PUCCH) indicated by a physical downlink control channel (PDCCH) to transmit within the transmission window, a physical uplink shared channel (PUSCH) scheduled by a PDCCH to transmit within the transmission window, a PUCCH resource carrying a periodic channel state information (CSI) report or a semi-persistent CSI report, a PUSCH with a Type 1configured grant, or a PUSCH with a Type 2 configured grant activated by a PDCCH.

In some embodiments, the configuration related to the beam report includes at least one of: a first configuration for a channel state information (CSI) report, wherein the first configuration indicates the one or more trigger events associated with the CSI report, a second configuration for the beam report that indicates at least one of the one or more trigger events, a report configuration identification, a reference signal for measurement, or a report quantity that indicates a content for the beam report, or a third configuration for the CSI report that includes a reporting configuration type set to event triggered. In some embodiments, the network device receives the beam report using a medium access control-control element (MAC CE) or a type of uplink control information (UCI).

In some embodiments, the beam report is received using the MAC CE that includes at least one of: a presence indication of the beam report, a cell indicator, a reference signal resource indicator, a report quantity that indicates a content of the beam report, or an identification of the trigger event. In some embodiments, the beam report is received using the MAC CE that is associated with only one beam report, or the beam report is received using the MAC CE that is associated with one beam report quantity that is associated with a reference signal. In some embodiments, the beam report is received using the MAC CE that is associated with more than one beam reports, or the beam report is received using the MAC CE that is associated with more than one report quantity that is associated with more than one reference signals. In some embodiments, the configuration related to the beam report configures a report quantity that indicates a content for the beam report, where at least one of following is configured: a reference signal receive power (RSRP) corresponds to an synchronization signal block (SSB) resource indicator, a RSRP corresponds to a channel state information reference signal resource indicator (CRI), a signal-to-noise and interference ratio (SINR) corresponds to a SSB index, or a SINR corresponds to a CRI.

In some embodiments, the network device transmits a second configuration related to a beam report indication message, the network device receives the beam report indication message from the communication device based on the second configuration in response to the trigger event of at least one beam report, and the beam report indication message indicates to the network device that at least one beam report has been triggered by an event corresponding to the at least one beam report. In some embodiments, the second configuration related to the beam report indication message includes a scheduling request configuration index or a physical uplink control channel (PUCCH) resource index. In some embodiments, a time or the transmission window for receiving the beam report is based on the transmission time of the beam report indication message. In some embodiments, the time or the transmission window for receiving the beam report starts or ends X milliseconds after the beam report indication message is transmitted, and a value for X is a physical uplink shared channel (PUSCH) preparation time, a configured value, or a predefined value.

In some embodiments, the time or the transmission window for receiving the beam report starts or ends at a symbol which is Y symbols later than an end symbol of the beam report indication message, and a value of Y is configured or predefined. In some embodiments, the time or the transmission window for receiving the beam report starts or ends at a slot which is Z slots later than another slot in which the beam report indication message is transmitted, and a value of Z is configured or predefined.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method implemented by a communication device, the wireless communication method comprising:
receiving a first configuration related to a beam report, wherein the first configuration indicates one or more trigger events that triggers the communication device to transmit the beam report;
receiving a second configuration related to a beam report indication message, wherein the beam report indication message indicates to a network device that at least one beam report has been triggered by an event corresponding to the at least one beam report; and
transmitting the beam report indication message and the beam report in response to an occurrence of a trigger event from the one or more trigger events, wherein the beam report is transmitted by the communication device in an uplink resource or in an uplink transmission.

2. The wireless communication method of claim 1, wherein the uplink resource or the uplink transmission is based on a Type 1 configured grant physical uplink shared channel (PUSCH) transmission configured in the first configuration related to the beam report.

3. The wireless communication method of claim 1, wherein the first configuration related to the beam report includes at least one of:
a third configuration for a channel state information (CSI) report, wherein the third configuration indicates the one or more trigger events associated with the CSI report,
a fourth configuration for the beam report that indicates at least one of the one or more trigger events, a report configuration identification, a reference signal for measurement, or a report quantity that indicates a content for the beam report, or a fifth configuration for the CSI report that includes a reporting configuration type set to event triggered.

4. The wireless communication method of claim 1, wherein the communication device transmits the beam report using a medium access control-control element (MAC CE) or a type of uplink control information (UCI).

5. The wireless communication method of claim 4, wherein the beam report is transmitted in a Part 1 Channel State Information, CSI, report.

6. The wireless communication method of claim 4, wherein the beam report is transmitted using at least one of:
the MAC CE that includes at least one of a reference signal resource indicator or a report quantity that indicates a content of the beam report, or
the MAC CE that is associated with only one beam report, or
the MAC CE that is associated with one beam report quantity that is associated with a reference signal.

7. The wireless communication method of claim 1, wherein the first configuration related to the beam report configures a report quantity that indicates a content for the beam report, and wherein the report quantity comprises a reference signal receive power (RSRP) corresponding to an synchronization signal block (SSB) resource indicator, or a RSRP corresponding to a channel state information reference signal resource indicator (CRI).

8. The wireless communication method of claim 1, wherein the second configuration related to the beam report indication message includes a scheduling request configuration index or a physical uplink control channel (PUCCH) resource index.

9. The wireless communication method of claim 1, wherein a time or a transmission window for transmitting the beam report is based on a transmission time of the beam report indication message, wherein the time or the transmission window for transmitting the beam report starts at a symbol which is Y symbols later than an end symbol of the beam report indication message, and wherein a value of Y is configured or predefined.

10. The wireless communication method of claim 1,
wherein the uplink resource or the uplink transmission is based on a physical uplink shared channel (PUSCH) transmission scheduled by a physical downlink control channel (PDCCH) that indicates a trigger state associated with the beam report, and
wherein the PDCCH scheduling the PUSCH transmission is received subsequent to the beam report indication message associated with the beam report being transmitted.

11. A wireless communication method implemented by a network device, the wireless communication method comprising:
transmitting a first configuration related to a beam report, wherein the first configuration indicates one or more trigger events that triggers a communication device to transmit the beam report;
transmitting a second configuration related to a beam report indication message, wherein the beam report indication message indicates to the network device that at least one beam report has been triggered by an event corresponding to the at least one beam report; and
receiving, from the communication device, the beam report indication message and the beam report in response to an occurrence of a trigger event from the one or more trigger events, wherein the beam report is received in an uplink resource or in an uplink transmission.

12. A wireless communication apparatus implemented by a communication device, the wireless communication apparatus comprising:
at least one processor configured to:
receive a first configuration related to a beam report, wherein the first configuration indicates one or more trigger events that triggers the communication device to transmit the beam report;
receive a second configuration related to a beam report indication message, wherein the beam report indication message indicates to a network device that at least one beam report has been triggered by an event corresponding to the at least one beam report; and
transmit the beam report indication message and the beam report in response to an occurrence of a trigger event from the one or more trigger events, wherein the beam report is transmitted by the communication device in an uplink resource or in an uplink transmission.

13. The wireless communication apparatus of claim 12, wherein the uplink resource or the uplink transmission is based on a Type 1 configured grant physical uplink shared channel (PUSCH) transmission configured in the first configuration related to the beam report.

14. The wireless communication apparatus of claim 12, wherein the first configuration related to the beam report includes at least one of:
a third configuration for a channel state information (CSI) report, wherein the third configuration indicates the one or more trigger events associated with the CSI report,
a fourth configuration for the beam report that indicates at least one of the one or more trigger events, a report configuration identification, a reference signal for measurement, or a report quantity that indicates a content for the beam report, or
a fifth configuration for the CSI report that includes a reporting configuration type set to event triggered.

15. The wireless communication apparatus of claim 12, wherein the communication device transmits the beam report using a medium access control-control element (MAC CE) or a type of uplink control information (UCI).

16. The wireless communication apparatus of claim 15, wherein the beam report is transmitted in a Part 1 Channel State Information, CSI, report.

17. The wireless communication apparatus of claim 15, wherein the beam report is transmitted using at least one of:
the MAC CE that includes at least one of a reference signal resource indicator or a report quantity that indicates a content of the beam report, or
the MAC CE that is associated with only one beam report, or
the MAC CE that is associated with one beam report quantity that is associated with a reference signal.

18. The wireless communication apparatus of claim 12, wherein the first configuration related to the beam report configures a report quantity that indicates a content for the beam report, and wherein the report quantity comprises a reference signal receive power (RSRP) corresponding to an synchronization signal block (SSB) resource indicator, or a RSRP corresponding to a channel state information reference signal resource indicator (CRI).

19. The wireless communication apparatus of claim 12, wherein a time or a transmission window for transmitting the beam report is based on a transmission time of the beam report indication message, wherein the time or the transmission window for transmitting the beam report starts at a symbol which is Y symbols later than an end symbol of the beam report indication message, and wherein a value of Y is configured or predefined.

20. A wireless communication apparatus implemented by a network device, the wireless communication apparatus comprising:
at least one processor configured to:
transmit a first configuration related to a beam report, wherein the first configuration indicates one or more trigger events that triggers a communication device to transmit the beam report;
transmit a second configuration related to a beam report indication message, wherein the beam report indication message indicates to the network device that at least one beam report has been triggered by an event corresponding to the at least one beam report; and
receive, from the communication device, the beam report indication message and the beam report in response to an occurrence of a trigger event from the one or more trigger events, wherein the beam report is received in an uplink resource or in an uplink transmission.
